(19) United States
(12) Patent Application Publication
(10) Pub. No.: US 2005/0073911 A1
(43) Pub. Date: Apr. 7, 2005

(54) Electronic prayer alert

(76) Inventor: Steven R. Barnett, Evansville, IN (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 10/960,237

(22) Filed: Oct. 6, 2004

Related U.S. Application Data
(60) Provisional application No. 60/508,593, filed on Oct. 6, 2003.

(51) Int. Cl. G04C 11/02; G04B 47/00

(52) U.S. Cl. 368/10; 368/47

(57) ABSTRACT

An electronic prayer alert that is programmed to alert users at pre-determined moments in time to say a prayer. The alert device includes a clock system which preferably receives a signal transmitted from a GPS satellite to the alert device's antenna, a CPU to decode the received signal, ROM that stores at least one pre-determined time during each twenty-four (24) hour period, and signal means. When the time of day in the clock system matches the pre-determined time(s) stored in ROM the CPU activates the signal means. The CPU and signal means is disposed in a variety of items, preferably an item that is commonly kept on the person such as, but not limited to, a bracelet, a pendant, a necklace, etc. The signal means can be a visual signal, an audible signal, a vibration, or any other signal to provide an output signal detectable by the person in possession of the electronic prayer alert.

### CROSS REFERENCES TO RELATED APPLICATIONS

U.S. Provisional Application for Patent No. 60/508,593, filed Oct. 6, 2003, with title “Electronic Prayer Alert” which is hereby incorporated by reference. Applicant claims priority pursuant to 35 U.S.C. Par. 119(e)(i).

Statement as to rights to inventions made under Federally sponsored research and development.

Not Applicable

### BACKGROUND OF THE INVENTION

1. Field of the Invention

The present invention relates generally to an electronic indicator for persons who wish to have regular prayer time and, more particularly, to an electronic device that is programmed to alert persons at pre-determined moments in time to pray. As a result, all persons in possession of the device will be alerted at the same moment to say a prayer.

2. Brief Description of Prior Art

A great many types of devices have been proposed to assist persons who wish to pray. U.S. Pat. No. D457,460 discloses a prayer medallion; U.S. Pat. Nos. 6,273,710, 6,270,339, 6,267,584 disclose a prayer candle device; U.S. Pat. No. D439,845 discloses a prayer clock; U.S. Pat. No. 6,202,035 discloses a system for determining time or direction for prayer using Global Positioning System (GPS) signals coming from satellites; U.S. Pat. No. 6,179,621 discloses a prayer strand marker; and U.S. Pat. No. 4,396,293 discloses a Muslim Salat time alarm timepiece. In addition, there are various similar devices currently available on the market which can be generally grouped into four categories: (1) Sports/Personal/Kitchen Countdown Timers & Stopwatches, (2) Medication Alert Timers & Watches, (3) Muslim Prayer Alarm Watches/Clocks, and (4) “Atomic” Watches/Clocks using radio receivers or GPS receivers.

While these prior art devices may satisfy their particular applications and objectives for which they were designed and marketed, none of the prior art discloses an electronic device that alerts all users simultaneously, in an accurate, globally-synchronized manner, to say a prayer at the same moment, and in effect, in unison.

As will be seen from the subsequent description, the preferred embodiments of the present invention overcome shortcomings of the prior art.

### SUMMARY OF THE INVENTION

The present invention relates to an electronic prayer alert that is programmed to alert persons at pre-determined moments in time to pray. The system generally comprises synchronizing the timing of the plurality of electronic prayer alert devices such that a predetermined control time period is likewise synchronized among the devices. As a result, all persons in possession of the device will be alerted simultaneously to say a prayer.

The electronic prayer alert generally includes a clock system which preferably receives a signal transmitted from a GPS satellite to the alert device's antenna. The received signal is decoded by the device's CPU. The decoded time data is maintained in a clock circuit of the device's clock system. The device further includes ROM that stores at least one pre-determined time during each twenty-four (24) hour period. When the time of day in the clock circuit matches the pre-determined time(s) stored in ROM the CPU activates signal. means to remind persons in possession of the alert device to say a prayer. ROM further stores an operational program for comparing the current time of day in the clock circuit with the pre-determined time data stored.

The CPU and signal means can be disposed in a variety of items, preferably an item that is commonly kept on the person such as, but not limited to, a bracelet, a pendant, a necklace, etc. The signal means can be a visual signal, an audible signal, a vibration, or any other signal to provide an output signal detectable by the person in possession of the electronic prayer alert.

### BRIEF DESCRIPTION OF THE DRAWINGS

FIG. 1 is a block diagram illustrating a structure of an electronic prayer alert in accordance with a first exemplary embodiment of the present invention.

FIG. 2 is a block diagram illustrating a structure of an electronic prayer alert in accordance with a second exemplary embodiment of the present invention.

FIG. 3 shows details of an item containing the prayer alert.

FIG. 4 shows a plurality of prayer alert devices signaled by a satellite.

FIG. 5 shows the program flow chart.

### DESCRIPTION OF THE PREFERRED EMBODIMENTS

In accordance with the present invention, an electronic prayer alert 10 is disclosed. The device 10 is programmed to simultaneously alert all users of the electronically prayer alert to say a prayer at a pre-determined moment. As a result, an unlimited number of users will be alerted at the same moment to say a prayer simultaneously and in effect, in unison.

Specifically, it will be noted in the following description that the device relates to a globally time-synchronized signaling system to remind users to pray. In the broadest context, the alert, device consists of components configured and correlated with respect to each other so as to attain the desired objective.

The Global Positioning System (GPS) is part of a satellite navigation system developed by the United States Defense Department under its NAVSTAR satellite program. Theoretically, multiple GPS satellites will have line of sight to most points on the Earth's surface. Each satellite carries a cesium or rubidium atomic clock to provide timing information. Internal clock correction is further provided for each satellite clock.

The signals continuously transmitted from each satellite utilize an extremely accurate frequency standard accomplished with the extremely accurate atomic clock.

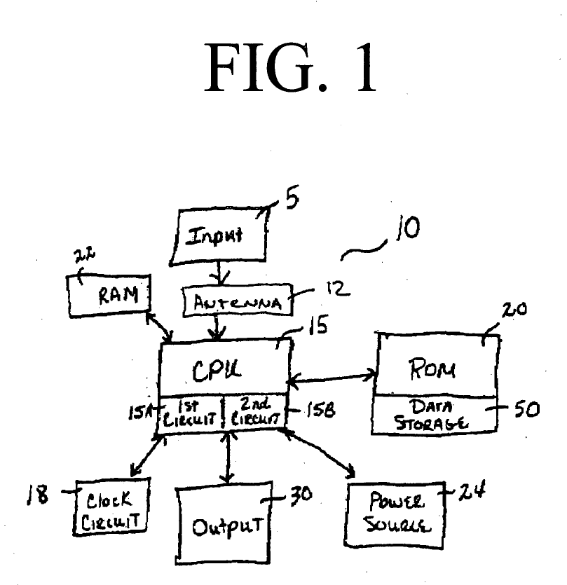

FIG. 1 illustrates the electronic prayer alert 10 in accordance with the first exemplary embodiment of the present invention. In the preferred embodiment, the electronic prayer alert 10 of the present invention includes a clock system which corrects automatically the time using data transmitted from a satellite 5.

This is known as an electronic clock system. In general, the prayer alert device 10 receives a signal “s” (see FIG. 4) transmitted from a GPS satellite 5 to the device's 10 antenna 12. The received signal “s” is converted to an intermediate frequency by a first circuit 15A of the device's 10 CPU 15. Then the intermediate frequency signal is decoded by a second circuit 15B of the CPU 15. Since the decoded data comprises time data, a GPS time (the time when the satellite transmits the signal) is determined and maintained in a clock circuit 18 of the device's clock system.

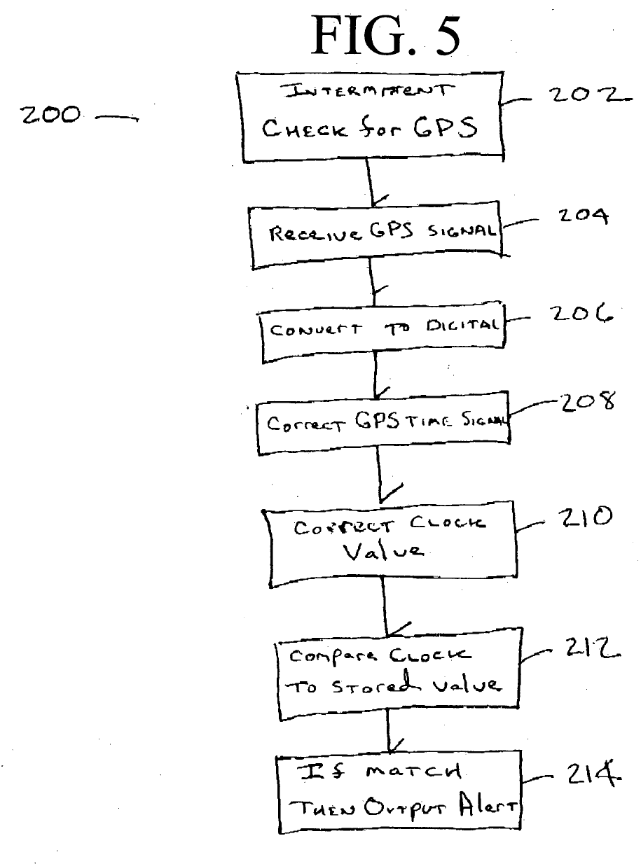

Antenna 12 is used for receiving 204 (see FIG. 5) a signal “s” from the satellite 5. The antenna 12 typically is one of two types: either a phased array antenna or a mechanical antenna. The phased array antenna tracks each satellite by using microelectronics that follow the satellite as it moves through the polar arc. Antennas with polar arc tracking capabilities are known in the art. Mechanical antennas are based on existing technology known in the art.

A signal “s” received by the antenna 12 from the satellite 5 is fed into the CPU 15 and the high frequency is converted to an intermediate frequency. As shown in FIG. 5, the signal converted 206 to the intermediate frequency is then converted to a digital signal. The digital signal is synchronized with the signal “s” from the satellite 5, thereby decoding the signal received from the satellite 5 and acquiring the time, data. Since the data transmitted from satellite is time data, CPU 15 works on the time data of the decoded signal and extracts the received satellite time.

In particular, ROM 20 stores an operational program 200 of device 10 for converting the received satellite time and decoding the signal as discussed above. CPU 15 uses RAM 22 as a working area for such work product. The time of clock circuit 18 is updated or corrected 210 with the resultant time.

CPU 15, ROM 20, RAM 22, clock circuit 18 and signal means 30 (as will be discussed) are coupled by internal BUS technology known in the art.

ROM 20 further includes a signal database 50 that has stored at least one pre-determined time during each twenty-four (24) hour period. As will be understood when the time of day in the clock circuit 18 is compared 212 and matches the pre-determined time(s) stored in the signal database 50 the CPU 15 activates the signal means 30 to remind users of the device 10 to say a prayer.

ROM 20 further stores an operational program of device 10 for comparing the current time of day in the clock circuit 18 with the pre-determined time data stored in the signal database 50.

The satellite time arrives at the device 10 with a traveling time delay. This traveling time varies depending on the distance between the device 10 and the satellite 15. ROM 20 can include an operational correctional program 208 to correct the received satellite time based on an average traveling time. As a result, each of the devices 10 distributed globally receive and maintain the identical time data.

The clock system of the present invention receives time data with high accuracy from the satellite and corrects 208 it based on an average traveling time. In other words, substantially any place fixed on Earth can receive a signal from the satellite so that the clock system disposed at the place can keep time with high accuracy.

In the preferred embodiment, the clock system as discussed above receives 204 signals from the satellite 5 intermittently 202, so that the alert device 10 consumes less power. As a result, a battery 24 can be used as a power source. For example, the program 200 could intermittently check 202 at a time near the pre-determined time stored in database 50 as determined by clock circuit 18.

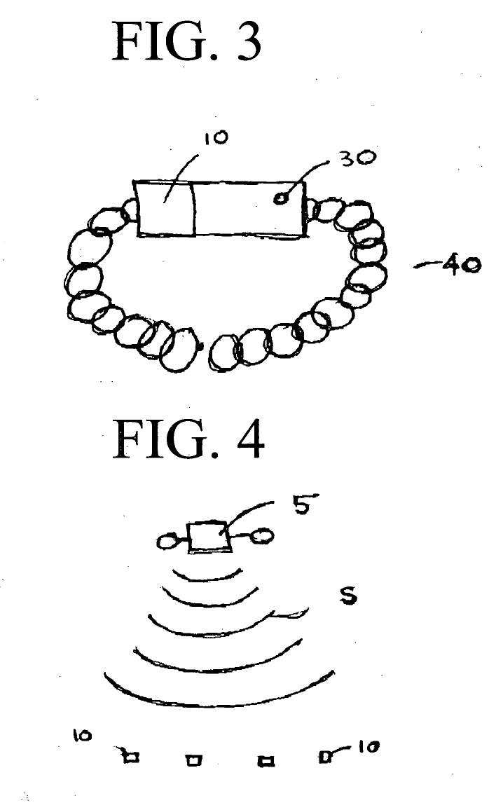

The CPU 15 and signal means 30 can be disposed in a variety of items 40 (see FIG. 3), preferably an item that is commonly kept on the person such as, but not limited to, a bracelet, a pendant, a necklace, etc.

As stated, the ROM 20 is pre-loaded with information during manufacture. ROM 20 is permanently loaded with a value(s) equal to moment(s) in time during a twenty-four (24) hour period the CPU 15 activates the signal means 30 as discussed. ROM 20 is further loaded with operational programs for the operation of the alert device 10 as discussed.

The CPU 15 functions to (1) receive, adjust and maintain the time data received from satellite, (2) reading the data stored in the ROM 20, (3) repeatedly determining when to activate the signal means 30, and (4) controlling the generation of the signal means 30.

The signal means 30 can be a visual signal, an audible signal, a vibration, or any other signal to provide an output signal detectable by the person in possession of the electronic prayer alert 10.

A judging operation 212 is conducted by the CPU 15 where the clock circuit 18 value is compared with the pre-determined value stored in the signal database 50. When the circuit 18 value (current time of day) is identical to the value stored in the database 50 in step 214, the signal means 30 is activated, and an alert signal is generated by the electronic prayer alert 10, alerting the user to say a prayer.

It should be understood that while the clock circuit 18 of the device 10 maintains current time data, the electronic prayer alert 10 is not a watch or time keeping device, nor does the electronic alert 10 display a time of day. The present invention is initialized with pre-determined moment(s) in time, and then performs its judging operations 214 as described above in order to regularly activate its signal means 30, thereby alerting all users of the electronic prayer alert 10 to say a pray.

The electronic prayer alert 10 can further include a selection means (not shown) operative for the user to selectively choose the preferred signal means namely a visual signal, an audible signal, a vibration, or any other signal provided.

In application, the electronic prayer alert 10 is preferably disposed as part of an apparatus or item 40 that is commonly kept on the person such as, but not limited to, a bracelet, a pendant, a necklace, etc. At the pre-determined moment in time when the clock circuit 18 value is identical in step 214 to the value stored in the signal database 50 of ROM 20, the CPU 15 activates the signal means 30, and an alert signal is generated by the electronic prayer alert 10, alerting the user to say a prayer. As a result, all users of an electronic prayer alert 10 disclosed herein will be alerted simultaneously to say a prayer.

Those of ordinary skill in the art will appreciate that there are other methods of supplying a highly accurate common time to the users, such as a synchronization unit that can be temporarily connected to the users via the network and that is dedicated to time synchronization, which synchronization unit generates a common time and supplies the common time to the users via the internet. Accordingly, such other methods of supplying a common time may be used without departing from the spirit and scope of the present invention.

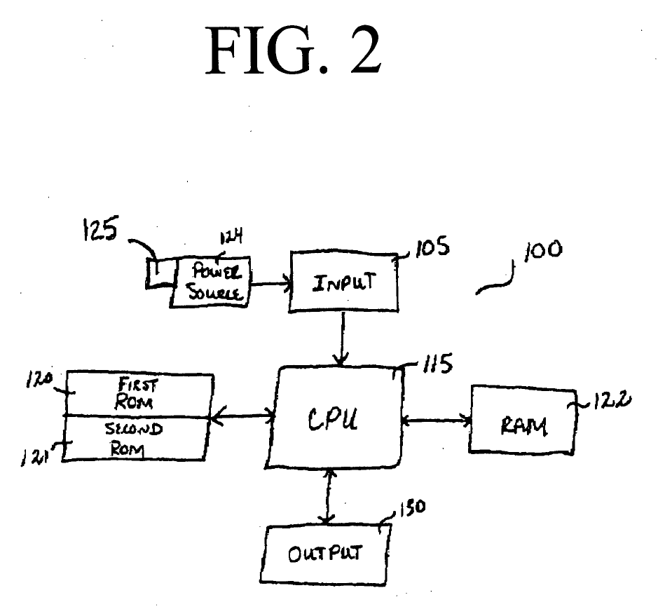

FIG. 2 illustrates an electronic prayer alert 100 in accordance with a second exemplary embodiment of the present invention. The electronic prayer alert 100 comprises a watch chip 105, a central processing unit 115, a random access memory 122, and first and second read only memory sections 120, 121 respectively. The CPU 115 is further connected to a signal means 130. The alert device 100 can be disposed in a variety of items, preferably an item 40 that is commonly kept on the person such as, but not limited to, a bracelet, a pendant, a necklace, etc.

The chip 105, and first and second read only memory sections 120, 121 are preloaded with information during manufacture. In particular, the chip 105 is loaded with a current time of day. The first read only memory section 120 is permanently loaded with a value equal to a moment in time the CPU 115 will initially activate the signal means 130 as will be further discussed. The second read only memory section 121 is permanently loaded with a value relevant to the CPU's 115 counting operation as to how often during a 24 hour period for example, the CPU 115 will activate the signal means 130 as will be further discussed. As will be understood, in order to achieve the desired objectives herein, it is critical that the components of the alert device 100 manufactured be loaded with identical values.

The CPU 115 performs the functions of (1) keeping the current value related to the counting operation, (2) reading the information stored in the first and second read only memory sections 120, 121, (3) repeatedly determining when to activate the signal means 130, and (4) controlling the generation of the signal means 130. The signal means 130 may be a visual signal, an audible signal, a vibration, or any other signal to provide an output signal detectable by the person in possession of the electronic prayer alert 100.

The counting operation of the CPU 115 is conducted to increment one count the equivalent of every one second. As such, for purpose of example only, if the first read only section 120 is loaded with the moment in time equal to 2:00 p.m. CST, and the second read only section 121 is loaded with the value of 86,400 (the number of seconds in a 24 hour period), then the CPU 115 will initially activate the signal means 130 at the programmed moment in time (2:00 p.m. CST). When the signal means 130 is activated a value stored in random access memory 122 (the “RAM value”) will re-set to zero and the counting operation will increment the RAM value one count every one second.

A judging operation is conducted by the CPU 115 where the RAM value is compared with the pre-determined value stored in the second read only memory section 121. When the RAM value is identical to the value stored in the second read only memory section 121, the signal means 130 is activated, and an alert signal is generated by the electronic prayer alert 100, alerting the user to say a prayer. When the signal means 130 is activated as described above, at that moment the RAM value is re-set to zero and the counting operation continues. More specifically, the CPU 115 functions to increment the value stored in the RAM value and to continuously update the RAM value by one count. That is, the RAM value is incremented by one count every one second and is re-set to zero when the RAM value equals the value stored in the second read only memory section 121.

It should be understood that while the first read only memory section 120 is initially loaded with a moment in time (2:00 p.m. CST in the above example), the electronic prayer alert 100 is not a watch or time keeping device, nor does the electronic alert 100 display a time of day. The electronic alert 100 is initialized with a pre-determined moment in time, and then performs its counting operation as described above in order to regularly activate its signal means 130, alerting users of the electronic prayer alert 100 to pray.

The electronic prayer alert 100 can further include a selection means (not shown) operative for the user to selectively choose the preferred signal means 130 namely a visual signal, an audible signal, a vibration, or any other signal provided.

In application, the electronic prayer alert 100 is preferably disposed as part of an apparatus or item 40 (FIG. 3) that is commonly kept on the person such as, but not limited to, a bracelet, a pendant, a necklace, etc. At the pre-determined moment in time when the RAM value is identical to the value stored in the second read only memory section 121, the signal means 130 is activated, and an alert signal is generated by the electronic prayer alert 100, alerting the user to say a prayer. As a result, the device 100 alerts all users simultaneously to say a prayer at the same moment.

As shown in FIG. 2, a battery 124 is used as a power source. The device 100 can further include an indicator 125 to display when the power source is low and the battery 124 needs replacing.

Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents, rather than by the examples given.

1. An electronic prayer alert comprising:
receiving means for receiving a signal originating from a satellite belonging to a GPS,
processing means for extracting time data from the received signal,
at least one pre-determined time value,
wherein said processing means further compares the time data and the pre-determined time value,
signal means for signaling when the time data is identical to the pre-determined time value.

2. The electronic prayer alert as recited in claim 1, wherein the processing means comprises:
a central processing unit having a first circuit and a second circuit, wherein the first circuit for receiving a signal transmitted from said satellite and converting the signal to an intermediate-frequency signal, and the second circuit for decoding the intermediate-frequency signal into time data,
a memory for permanently storing the at least one pre-determined time value, and
an operational program for comparing the time data and the pre-determined time value.

3. The electronic prayer alert as recited in claim 2, wherein the at least one pre-determined time value is pre-loaded in the memory during manufacture.

4. The electronic prayer alert as recited in claim 1, wherein the receiving means comprises an antenna.

5. The electronic prayer alert as recited in claim 1, wherein the signal means is a visual signal.

6. The electronic prayer alert as recited in claim 1, wherein the signal means is an audible signal.

7. The electronic prayer alert as recited in claim 1, further comprising a power source for supplying power.

8. The electronic prayer alert as recited in claim 1, wherein said processing means includes correction means correcting time dated to give corrected time data from said signal based on a distance traveled by said signal and correcting an internal clock based on the corrected time data.

9. A signaling device comprising:
a time synchronization unit,
processing means for extracting time data from said time synchronization unit,
at least one pre-determined time value,
wherein said processing means further compares the time data and the pre-determined time value,
signal means for signaling when the time data is identical to the pre-determined time value.

10. The signaling device as recited in claim 9, wherein the time synchronization unit comprises receiving means for receiving a signal originating from a satellite belonging to a GPS.

11. The signaling device as recited in claim 9, wherein the processing means comprises:
a central processing unit, a memory for permanently storing the at least one pre-determined time value, and an operational program for comparing the time data and the pre-determined time value.

12. The signaling device as recited in claim 11, wherein the at least one pre-determined time value is pre-loaded in the memory during manufacture.

13. The signaling device as recited in claim 10, wherein the receiving means comprises an antenna.

14. The signaling device as recited in claim 9, wherein the signal means is a visual signal.

15. The signaling device as recited in claim 9, wherein the signal means is an audible signal.

16. A signaling device comprising:
a watch chip for transmitting time data,
a central processing unit,
a first memory loaded with at least one pre-determined time value,
a second memory loaded with a sequence value,
wherein the central processing unit comprising:
a counting operation that generates a count, and
a judging operation, wherein said judging operation compares the count with the pre-determined time value such that when the count is identical to the time value the central processing unit activates a signal means.

17. The signaling device as recited in claim 16, wherein when the count is identical to the time value the count is reset to a zero value.

18. The signaling device as recited in claim 16, wherein the signal means is a visual signal.

19. The signaling device as recited in claim 16, wherein the signal means is an audible signal.

20. An electronic prayer alert comprising:
a plurality of spaced receiving devices for receiving a signal originating from a satellite belonging to a GPS,
each receiving device including a processor for extracting time data from the received signal,
at least one pre-determined time value stored in each said receiving device,
wherein said processor further compares the time data and the pre-determined time value,
an output signal for signaling when the time data is identical to the pre-determined time value such that each device will create an output signal simultaneously.

21. The electronic prayer alert as recited in claim 20, wherein said each device includes a signal correction program to correct for a travel time of said satellite signal such that output signals will occur simultaneously for said each receiving device.

22. The electronic prayer alert as recited in claim 20, wherein said each device includes an internal clock and a time indicated by said internal clock is updated using said time data and said time indicated by said internal clock is compared to said pre-determined time value.

23. A method of simultaneously alerting people spaced apart on a globe including the steps of:
storing a pre-determined time on a plurality of receiving devices,
checking intermittently from each receiving device for a signal from a satellite,
receiving a satellite signal at said each receiving device,
converting said satellite signal to a digital signal within said each receiving device,
extracting time data from said digital signal within said each receiving device,
correcting said time data for a distance traveled by said satellite signal to said each receiving device,
correcting a clock value within said each receiving device,
comparing the clock value to said pre-determined time within each receiving device,
creating an alert signal from said each receiving device when said pre-determined time matches said clock value within said each receiving device such that said alert signals occur simultaneously.

24. The method as recited in claim 23, including the step of mounting each said receiver in a portable personal item.
